(19) United States
(12) Patent Application Publication
(10) Pub. No.: US 2022/0013260 A1
(43) Pub. Date: Jan. 13, 2022

(54) ELECTRIC RESISTOR, HONEYCOMB STRUCTURE, AND ELECTRICALLY HEATED CATALYST DEVICE

(71) Applicant: DENSO CORPORATION, Kariya-city (JP)

(72) Inventors: Takehiro TOKUNO, Kariya-city (JP); Junichi NARUSE, Kariya-city (JP); Yasushi TAKAYAMA, Kariya-city (JP)

(21) Appl. No.: 17/448,735

(22) Filed: Sep. 24, 2021

Related U.S. Application Data
(63) Continuation of application No. PCT/JP2020/002109, filed on Jan. 22, 2020.

(30) Foreign Application Priority Data
Mar. 27, 2019 (JP) 2019-061701

(51) Int. Cl. H01C 13/00; H05B 3/18; B01J 35/04; B01J 21/08

(52) U.S. Cl. CPC H01C 13/00; B01J 21/08; B01J 35/04; H05B 3/18

(57) ABSTRACT

An electric resistor includes a particle continuous body in which a plurality of conductive particles are connected, and a matrix disposed around the particle continuous body. The particle continuous body has surface-joined portions in which surfaces of the conductive particles are joined to each other. Silicon particles are preferably used as the conductive particles. The average boundary line length of the surface-joined portions is preferably 0.5 μm or more.

### CROSS-REFERENCE TO RELATED APPLICATION

The present application is a continuation application of International Application No. PCT/JP2020/002109 filed on Jan. 22, 2020, which is based on and claims the benefit of priority from Japanese Patent Application No. 2019-061701 filed on Mar. 27, 2019. The contents of these applications are incorporated herein by reference in their entirety.

### BACKGROUND

The present disclosure relates to an electric resistor, a honeycomb structure, and an electrically heated catalyst device.

Conventionally, electric resistors have been used for energizing and heating in various fields. For example, in the vehicle field, an electrically heated catalyst device is known in which a honeycomb structure supporting a catalyst is composed of an electric resistor such as a SiC resistor, and the honeycomb structure is heated by electrical energization.

### SUMMARY

One aspect of the present disclosure is an electric resistor comprising a particle continuous body in which a plurality of the conductive particles are connected, where the particle continuous body has surface-joined portions in which surfaces of the conductive particles are joined.

Another aspect of the present disclosure is a honeycomb structure that is configured to include the above electric resistor.

Yet another aspect of the present disclosure is an electrically heated catalyst device having the above honeycomb structure.

The reference signs in parentheses set out in the claims indicate correspondence with specific means described in embodiments hereinafter, and do not limit the technical scope of the present disclosure.

### BRIEF DESCRIPTION OF THE DRAWINGS

The above objects and other objects, features and advantages of the present disclosure will be made clearer by the following detailed description, given referring to the appended drawings. In the drawings:

FIG. 1 is a schematic explanatory view illustrating a cross section of an electric resistor according to a first embodiment.

FIG. 2 is a schematic explanatory view illustrating a part of an EBSD image of a cross section of an electric resistor according to the first embodiment.

FIG. 3 is a schematic explanatory view illustrating the honeycomb structure of the second embodiment.

FIG. 4 is a schematic explanatory view illustrating an electrically heated catalyst device according to a third embodiment. FIG. 5 is an EBSD image of a cross section of an electric resistor sample 1, prepared in an experimental example.

FIG. 6 is an EBSD image of a cross section of the electric resistor of the electric resistor sample 1 prepared in the experimental example (with different magnification from that of FIG. 5).

FIG. 7 is an EBSD image of a cross section of an electric resistor sample 1C, prepared in an experimental example.

### DETAILED DESCRIPTION OF THE PREFERRED EMBODIMENTS

A ceramic electric resistor, for example, has been proposed as the electric resistor, obtained by firing a mixture of silicon particles, borosilicate glass or boric acid, and kaolin, at a temperature in the range 1250° C. to 1300° C. JP 2019-12682 A also proposes a ceramic electric resistor.

In a conventional electric resistor, conductive paths are formed by point contacts between silicon particles. When the conventional electric resistor is exposed to a high temperature oxidizing atmosphere at 1000° C., oxidation occurs on the portions of the silicon particle where there is contact between them, causing an insulating oxide film to be formed on these portions. As a result, the problem arises that the conductive paths are interrupted or constricted at the portions of the silicon particle where there is contact between them, causing the electrical resistance of the conventional electric resistor to rapidly increase.

It is an object of the present disclosure to provide an electric resistor capable of suppressing an increase in electrical resistance even when exposed to a high temperature oxidizing atmosphere at 1000° C.

One aspect of the present disclosure is an electric resistor comprising a particle continuous body in which a plurality of the conductive particles are connected, and a matrix around the particle continuous body, where the particle continuous body has surface-joined portions in which surfaces of the conductive particles are joined.

Another aspect of the present disclosure is a honeycomb structure that is configured to include the above electric resistor.

Yet another aspect of the present disclosure is an electrically heated catalyst device having the above honeycomb structure.

The above electric resistor can suppress an increase in electrical resistance even when exposed to a high temperature oxidizing atmosphere at 1000° C.

Since an increase in electrical resistance can be suppressed even when exposed to a high-temperature oxidizing atmosphere at 1000° C., a constant rate of temperature increase can be achieved for the above honeycomb structure.

Since an increase in the electrical resistance of the honeycomb structure can be suppressed even when exposed to a high temperature oxidizing atmosphere of 1000° C. in an exhaust gas environment, a constant rate of temperature increase can be achieved for the electrically heated catalyst device. In addition, improved thermal durability can be achieved for the electrically heated catalyst device.

The electric resistor of the present embodiment includes a particle continuous body in which a plurality of conductive particles are connected, and a matrix surrounding the particle continuous body. The particle continuous body has surface-joined portions in which surfaces of the conductive particles are joined to each other.

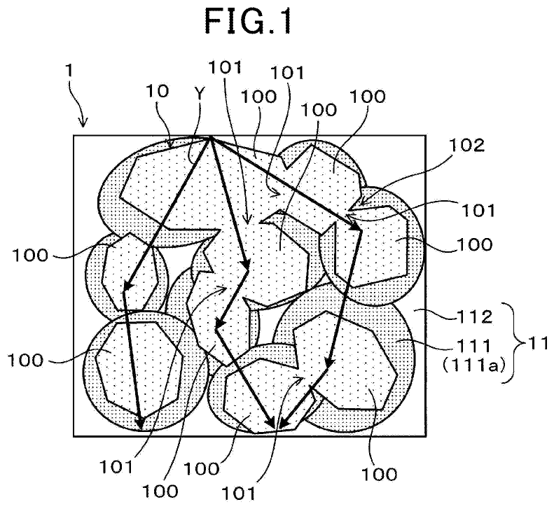

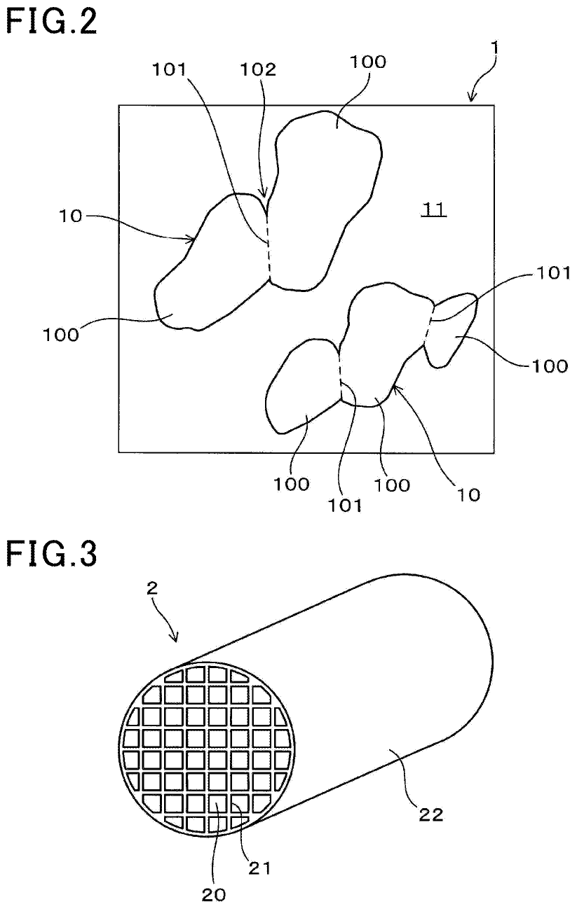

Since the particle continuous body in the electric resistor of the present embodiment has surface-joined portions in which surfaces of the conductive particles are joined to each other, and the surface-joined portions remain present even when the electric resistor is exposed to an oxidizing atmosphere at a temperature as high as 1000° C., a conductive path through the surface-joined portions does not readily become interrupted or constricted. The electric resistor of the present embodiment can thus suppress an increase in electrical resistance even when exposed to an oxidizing atmosphere at a temperature as high as 1000° C. The electric resistor of the present embodiment will be described in the following with reference to FIGS. 1 and 2.

### First Embodiment

As illustrated in FIG. 1, an electric resistor 1 includes a particle continuous body 10 and a matrix 11. The particle continuous body 10 is formed of a connected plurality of conductive particles 100, and has surface-joined portions 101 in which the conductive particles 100 are joined to each other at their surfaces. FIG. 1 illustrates a particle continuous body 10 having a constricted portion 102 at part of a surface-joined portion 101. The arrow Y shown in FIG. 1 indicates a conductive path.

The fact that the particle continuous body 10 has the surface-joined portions 101 can be confirmed by performing electron backscatter diffraction (which may be simply referred to as EBSD in the following) on a cross section of the electric resistor 1. EBSD is known as a method for analyzing the distribution of orientations of crystal grains by calculating the crystal orientation of a continuously captured pattern, based on information on the crystal structure of a measurement sample. Specifically, as illustrated in FIG. 2, when it is found by crystal orientation analysis using an EBSD device that there is a boundary line 101a between conductive particles 100 constituting a particle continuous body 10, is judged that the particle continuous body 10 has a surface-joined portion 101. The boundary line 101a which is seen in the EBSD image at the surface-joined portion 101 is considered to be caused by disturbance of the crystal orientation of the material constituting the conductive particles 100, at the surface-joined portion 101. Hence it is technically incorrect to judge that the existence of the boundary line 101a signifies that the conductive particles 100 are not connected to each other. This can be readily understood by comparing an SEM image and an EBSD image taken at the same location.

The average boundary line length of the surface-joined portions 101, obtained by EBSD as described above, can be made 0.5 μm or more. This configuration enables an increase in electrical resistance of the electric resistor 1 to be suppressed, and the oxidation resistance of the electric resistor 1 to be ensured, even when exposed to an oxidizing atmosphere at a temperature as high as 1000° C. The average boundary line length can preferably be made greater than 1 μm, more preferably greater than 2 μm, or still more preferably greater than 4 μm. From the aspect of productivity, and considerations of cell wall thickness uniformity when the electric resistor 1 is used for a honeycomb structure, etc., the average boundary line length can be made less than 10 μm. To obtain the average boundary line length, 5 EBSD images were acquired for respective cross sections of the electric resistor 1, the lengths of the boundary lines 101a of the surface-joined portions 101 were measured for all the particle continuous bodies 10, and the average of the measured values was taken as the average boundary line length. Boundary lines 101a that extend to the exterior of the field of view are not counted, since the exact length is unknown. Furthermore, in measuring the average boundary line length of the surface-joined portion 101 by EBSD, if the magnification is increased excessively, a plurality of particle continuous bodies 10 will not be contained within one visual field. Hence the magnification is made such that a plurality of particle continuous bodies 10 can be contained within the field of view. Specifically, the magnification can be made 3500 times, and an EBSD image acquired that is in the range of 20 μm x 20 μm.

The resistance of an electric resistor used as a resistance heating element increases as the duration of use increases, and (depending on the application) the electric resistor is generally replaced when its electrical resistance has become tripled. Hence the threshold value for the material structure can be set as the point at which the electrical resistance has increased by a factor of three. Specifically, the electrical resistance can be calculated from the formula:

R=ρ×L/A

where R [Ω] is electrical resistance, ρ [Ω·m] is electrical resistivity, L [m] is length, A [m²] is cross-sectional area. Since the current flow becomes constricted at a surface-joined portion 101 between conductive particles 100, the amount of decrease in the cross-sectional area of the surface-joined portions 101 controls the amount of increase in electrical resistance of the electric resistor when in a high-temperature oxidizing atmosphere. Assuming that the oxide film thickness of the material constituting the conductive particles used for the resistance heating element is 100 nm, then when the conductive area of a surface-joined portion 101 has become reduced and when the electrical resistance of the electric resistor increases by three times, the boundary line length is 0.5 μm. More specifically, if the diameter of the surface-joined portion 101 is 0.5 μm, the cross-sectional area is 0.25×0.25×3.14=0.196 μm². Assuming that the surface-joined portion 101 is oxidized from the outer surface to the interior by 0.1 μm, the diameter of the surface-joined portion 101 becomes 0.3 μm, and the cross-sectional area of the surface-joined portion 101 becomes 0.15×0.15×3.14=0.071 μm². That is, due to the oxidation, the cross-sectional area of the surface-joined portion 101 is reduced to about ⅓ of its size and the electrical resistance is increased by about 3 times. Thus, by setting the average boundary line length of the surface-joined portions 101 as 0.5 μm or more, sufficient resistance of the electric resistor 1 to oxidation can be ensured. One of the reasons for assuming an oxide film thickness of 0.1 μm in the above is as follows. Silicon, for example, may be used as the material constituting the conductive particles. Oxidation of the silicon proceeds when the silicon is exposed to an oxidizing atmosphere at a temperature of about 1000° C. In the initial stages of oxidation, an interfacial reaction is the factor determining the reaction rate, and the surface becomes oxidized to about 40 nm in a relatively short time. It is known that when a SiO₂ oxide film on a silicon surface is oxidized to a depth of 40 nm or more, the oxide film functions as a barrier to oxygen gas, so that the oxidation rate decreases. The oxidation rate of the silicon thus becomes moderate, and in a dry environment the oxidation proceeds only to about 100 nm. A wet oxidation process can further oxidize the silicon. If it is assumed that the electric resistor is for use in a dry environment, the conditions can be set such that the silicon surface will be oxidized to 100 nm during use.

The electric resistor 1 can be configured such that the number of surface-joined portions 101 having a boundary line length of 0.5 μm or more is preferably 5 or more, more preferably 10 or more, still more preferably 20 or more. With this configuration, the average boundary line length of the surface-joined portion 101 can readily be set to 0.5 μm or more, so that the effect of suppressing an increase in electrical resistance when exposed to a high-temperature oxidizing atmosphere at 1000° C. can readily be obtained and the thermal resistance of the electric resistor 1 can readily be improved. The number of surface-joined portions 101 that are present can be judged by counting those surface-joined portions 101 which have a boundary line length of 0.5 μm or more, in an EBSD image acquired in the area of 20 μm×20 μm as described above.

The conductive particles 100 can be made of a material whose surface can be oxidized. With this configuration, even when insulation proceeds on the surface of a particle continuous body 10 due to oxidation of the conductive particles 100, insulation of the surface-joined portions 101 due to the oxidation is unlikely to occur. Hence this configuration enables an electric resistor 1 to be obtained which exhibits the effect of suppressing an increase in electrical resistance when exposed to a high-temperature oxidizing atmosphere at 1000° C. If a particle continuous body 10 has a constricted portion 102 in part of a surface-joined portion 101, the surface of the constricted portion 102 is particularly readily oxidized, so that the effect achieved by adopting the above configuration can be fully exhibited.

Silicon particles (Si particles) or the like are examples of a suitable material for constituting the conductive particles 100. A SiO₂ thin film is formed on the surface of silicon by oxidation. The conductive particles 100 in the electric resistor 1 can be formed of silicon particles. In a material in which silicon particles play a major role in forming a conductive path, it is considered that an increase in electrical resistance of the material in a high-temperature oxidizing atmosphere at 1000° C. is due to interruption or constriction of conductive paths between silicon particles, due to surface oxidation of the silicon particles However since an electric resistor 1 having the above configuration has surface-joined portions 101 in which silicon particles are joined to each other, sufficiently large areas of joining between silicon particles can be secured. When the surface of the silicon particles constituting a particle continuous body 10 is oxidized, an insulating SiO₂ thin film is formed on the surface of the particle continuous body 10, but when the oxidation proceeds beyond a certain level, the SiO₂ thin film becomes a gas barrier film. Oxygen gas is thus made less likely to enter the interior of the surface-joined portions 101, so that oxidation is suppressed. Thus, with the above configuration, even when silicon particles are used as the conductive particles 100, a conductive path is made less likely to be interrupted or constricted, and hence the oxidation resistance can be improved.

A matrix 11 surrounds the particle continuous body 10. As illustrated in FIG. 1, the electric resistor 1 can include a plurality of particle continuous bodies 10, which are electrically connected to each other, directly or via a conductive phase 111. In that case, from the aspect of securing a conductive path, it is preferable that in the initial state there is no oxide film present between adjacent ones of the plurality of particle continuous bodies 10, where the oxide film is formed by oxidization of the material constituting the conductive particles 100. Such a condition can be achieved by firing in an inert gas atmosphere such as an Ar gas atmosphere.

As illustrated in FIG. 1, the matrix 11 can be specifically configured to have a conductive phase 111 and an insulating phase 112. The conductive phase 111 can include, for example, a conductive coating portion 111a that covers the surface of the particle continuous body 10. With this configuration, adjacent particle continuous bodies 10 are electrically connected to each other via the conductive coating portions 111a. This is advantageous for forming a conductive path. The conductive coating portion 111a may cover the entire surface of the particle continuous body 10 or a part thereof. The conductive coating portion 111a can be made of borosilicate, for example, from the aspect of forming a conductive path between the particle continuous bodies 10. Furthermore, the conductive phase 111 may contain only conductive particles, or may contain borosilicate or the like that does not cover the surface of the particle continuous body 10. Examples of conductive particles that can be contained alone include silicon particles (Si particles) and silicide particles. The silicide particles may be, for example, at least one type that is selected from a group consisting of TiSi₂, TaSi₂ and CrSi₂, with CrSi₂ being preferable from the aspect of a good balance between resistance to oxidation and low volumetric expansion. On the other hand, the insulating phase 112 can be composed of insulating particles. Examples of insulating particles include cordierite particles. Cordierite has a lower coefficient of thermal expansion than alumina, mullite, and the like. Hence with this configuration, the coefficient of thermal expansion of the electric resistor 1 can readily be reduced. Furthermore, since cordierite melts at a temperature of 1300° C. or higher, so that the material structure of the electric resistor 1 becomes dense at such a temperature, it is made difficult for oxygen gas to permeate into the material. Hence, the oxidation resistance of the electric resistor 1 can be improved with this configuration. It should be noted that the electric resistor 1 may include pores.

The matrix 11 can include borosilicate and cordierite. With this configuration, a good balance is achieved between securing a conductive path, reducing the coefficient of thermal expansion, and improving the oxidation resistance by densification, which suppresses the permeation of oxygen gas into the material of the matrix 11. If necessary, the matrix 11 may also contain one or more of a filler, a material for lowering the coefficient of thermal expansion, a material for increasing the thermal conductivity, a material for improving the strength, etc.

The electric resistor 1 can be configured such that the rate of change in electrical resistance after being held in an atmosphere of air at 1000° C. for 50 hours is 200% or less. This configuration provides good resistance to oxidation in a high temperature oxidizing atmosphere at 1000° C. From the aspect of improving oxidation resistance, the rate of change in electrical resistance is preferably made 150% or less, more preferably 100% or less, still more preferably 50% or less. Furthermore, in the case of an electric resistor for use in an electrically heated catalyst device, the rate of change in electrical resistance can be made 35% or less, or even more preferably 30% or less, from the aspect of preserving circuit elements.

The rate of change in electrical resistance was measured as follows. For each sample of the electric resistor 1, the electrical resistivity of the sample was measured before holding the sample in air at a temperature of 1000° C. for 50 hours (that is, the initial value of electrical resistivity) and after holding the sample at that temperature for 50 hours. The electrical resistivity of the electric resistor 1 is the average value of measured values (n=3) measured by the four-terminal method. The rate of change in electrical resistivity is defined as the absolute value of the result calculated from the following formula:

100×{(electric resistivity after holding at 1000° C. for 50 hours)−(initial electrical resistivity before holding at 1000° C. for 50 hours)}/(initial electrical resistivity before holding at 1000° C. for 50 hours)

The electric resistor 1 preferably has an electric resistivity of 0.0001 Ω·m or more, 1 Ω·m or less and a rate of change in electrical resistance of 0/K or more, 5.0×10⁻⁴/K or less, within a temperature range of 25° C. to 500° C. Since the temperature dependence of the electric resistor 1 having this configuration is small, temperature distribution is unlikely to occur during energization heating, so that cracking caused by thermal expansion and contraction is unlikely to occur. Furthermore, since the electric resistor 1 can be heated at a lower temperature in an early stage of energization heating, the configuration is advantageous for use as a material of a honeycomb structure which is required to be heated at an early stage, for rapid activation of a catalyst.

The electrical resistance of the electric resistor 1 varies depending on the specifications required for the system in which it is used, however from the aspect of reducing electrical resistance, the electrical resistivity can preferably be made 0.5 Ω·m or less for example, or more preferably 0.1 Ω·m or less, or still more preferably 0.05 Ω·m or less. From the aspect of increasing the amount of heat generated during energization heating, the electrical resistivity of the electric resistor 1 is preferably made 0.0002 Ω·m or more, more preferably 0.0005 Ω·m or more, or still more preferably 0.001 Ω·m or more.

From the aspect of facilitating the suppression of temperature distribution caused by energization heating, the rate of increase in electrical resistivity of the electric resistor 1 is preferably made 0.001×10⁻⁶/K or more, more preferably 0.01×10⁻⁶/K or more, or still more preferably 0.1×10⁻⁶/K or more. From the aspect of an rate of increase in electrical resistance the electric resistor 1 that will provide an optimum value of electrical resistance value for energization heating in an electric circuit, ideally the electrical resistance should not change, however the rate of increase in electrical resistance can preferably be made 100×10⁻⁶ /K or less, more preferably 10×10⁻⁶/K or less, or still more preferably 1×10⁻⁶/K or less.

The electrical resistivity of the electric resistor 1 is the average value of measured values (n=3) measured by the four-terminal method. The rate of increase in electrical resistance of the electric resistor 1 can be calculated by the following method, after measuring the electrical resistivity of the electric resistor 1 by the above method. First, the electrical resistivity is measured at the three temperature points of 50° C., 200° C., and 400° C. The value derived by subtracting the electrical resistivity at 50° C. from the electrical resistivity at 400° C. is then divided by the temperature difference of 350° C. between 400° C. and 50° C., to calculate the rate of increase in electrical resistance.

### Second Embodiment

The honeycomb structure of a second embodiment will be described with reference to FIG. 3. It should be noted that the reference signs used in the second and subsequent embodiments represent the same components, etc., as in the preceding embodiments, unless otherwise specified.

As shown in FIG. 3, the honeycomb structure 2 of the present embodiment includes the electric resistor 1 of the first embodiment. Specifically, in the present embodiment, the honeycomb structure 2 is composed of the electric resistor 1 of the first embodiment. FIG. 3 is a cross-sectional view taken at right angles to the central axis of the honeycomb structure 2, showing a configuration having a plurality of cells 20 respectively adjacent to each other, cell walls 21 forming the cells 20, and an outer peripheral wall 22 provided at a peripheral part of the cell walls 21 for integrally retaining the cell walls 21. A known structure can be applied as the honeycomb structure 2, which is not limited to the structure shown in FIG. 3. FIG. 3 shows an example in which the cells 20 have a quadrangular cross section, however it would be equally possible, for example, for the cells 20 to have a have a hexagonal cross section. Furthermore FIG. 3 shows an example in which the honeycomb structure 2 has a cylindrical shape, however it would be equally possible, for example, for the honeycomb structure 2 to have a track shape or the like in cross-section.

The honeycomb structure 2 of the present embodiment is configured to include the electric resistor 1 of the first embodiment. Hence, an increase in the electrical resistance of the honeycomb structure 2 can be suppressed, even when exposed to a high temperature oxidizing atmosphere at 1000° C. Since the rate of heat generation increases in proportion to the electrical resistance, the honeycomb structure 2 of the present embodiment enables a constant heating rate to be achieved.

### Third Embodiment

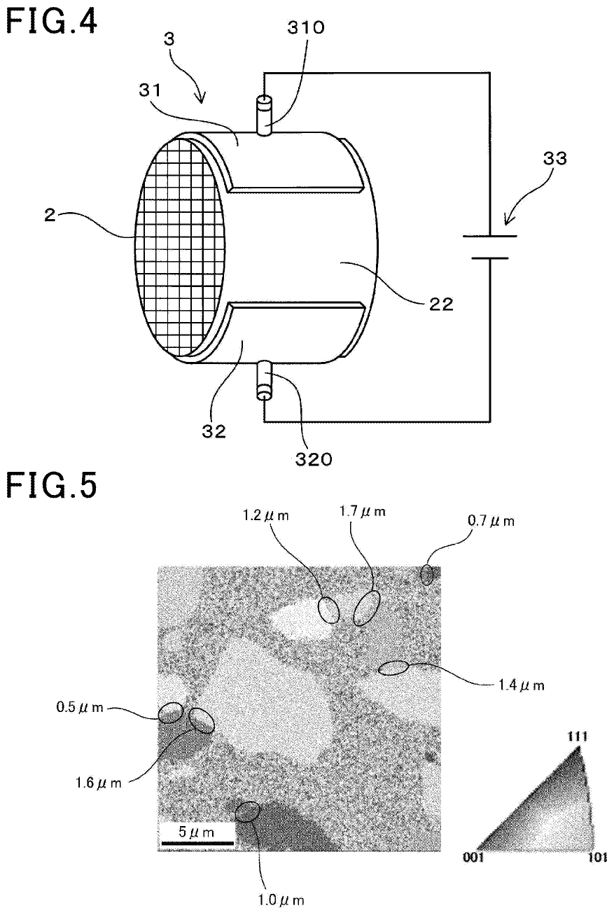

An electrically heated catalyst device of a third embodiment will be described with reference to FIG. 4. As illustrated in FIG. 4, the electrically heated catalyst device 3 of the present embodiment has the honeycomb structure 2 of the second embodiment. Specifically, the electrically heated catalyst device 3 of the present embodiment includes the honeycomb structure 2, an exhaust gas purification catalyst (not shown) supported on the cell walls 21 of the honeycomb structure 2, a pair of electrodes 31 and 32 disposed facing each other on the outer peripheral wall 22, and a voltage applying unit 33 that applies a voltage to the electrodes 31 and 32, and controls the voltage. The voltage is applied to the electrodes 31 and 32 respectively through rod-shaped electrode terminals 310 and 320. A known structure can be used for the electrically heated catalyst device 3, and the structure is not limited to that shown in FIG. 4. Furthermore, the voltage application may be any form, such as DC, AC, pulsed voltage, etc., or a combination of such forms.

The electrically heated catalyst device 3 of the present embodiment has the honeycomb structure 2 of the second embodiment, and hence can suppress an increase in the electrical resistance of the honeycomb structure 2 even when exposed to a high temperature oxidizing atmosphere at 1000° C. in an exhaust gas environment, so that a constant heating rate can be realized. Furthermore, the electrically heated catalyst device 3 of the present embodiment is also advantageous in that the thermal durability is increased.

### Experimental Examples

### Preparation of Sample 1, Sample 2, Sample 3, Sample 1C, Sample 2C

Silicon (Si) particles (average particle size 7 μm), boric acid and cordierite were mixed at the mass ratio shown in Table 1. Then, 4% by mass of methyl cellulose was then added as a binder to this mixture, water was added, and the mixture was mixed. Next, the obtained mixture was molded into pellets by an extrusion molding machine, dried at 80° C. in a constant temperature tank, and then degreased. The degreasing conditions were: atmosphere of air, at normal pressure, degreasing temperature 700° C., and degreasing time 3 hours.

Next, the degreased fired body was subjected to provisional firing. The provisional firing conditions were: Ar gas atmosphere, normal pressure, provisional firing temperature shown in Table 1, and provisional firing time of 30 minutes. In Table 1, the firing temperature of a sample that has not been subjected to provisional firing is specified as “none” (specifically, sample 1C).

Next, the obtained fired body was main fired. The conditions for the main firing were an Ar gas atmosphere, normal pressure, the main firing temperature shown in Table 1, and a firing time of 30 minutes.

Next, the obtained fired body was subjected to pre-oxidation treatment (oxidation aging). The pre-oxidation conditions were: atmosphere of air at normal pressure, treatment temperature 1000° C., and treatment time 10 hours. As a result, the electric resistors of sample 1, sample 2, sample 3, sample 1C, and sample 2C, each having a form of 5 mm×5 mm×25 mm, were obtained.

### Preparation of Sample 3C and Sample 4C

This was the same as for sample 1, except that to obtain the electric resistors of sample 3C and sample 4C, a mixture of silicon particles, boric acid and kaolin in the mass ratio shown in Table 1 was used, provisional firing was not performed, and the above pre-oxidation treatment was not performed.

### EBSD Observation

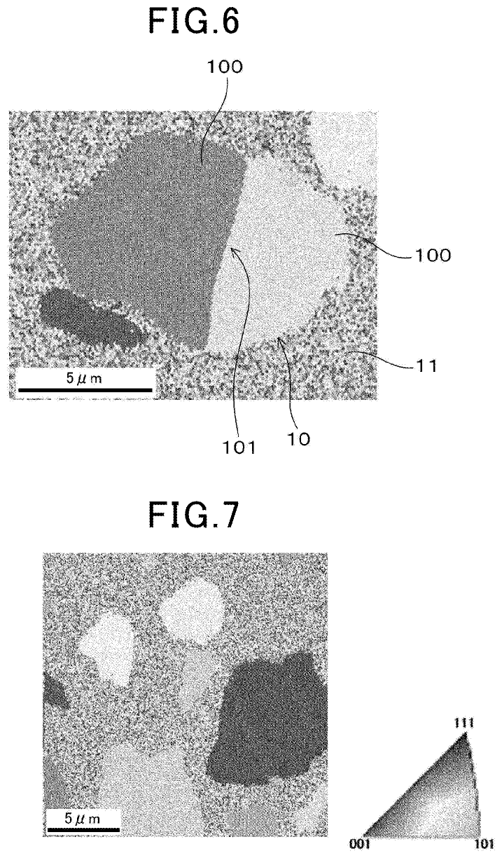

EBSD observation was performed on cross-sections of the electric resistor of each sample. The JEOL-JSM7100M manufactured by the JEOL company was used as the EBSD device. The crystal orientation of the silicon was thereby detected, and EBSD images color-coded for each crystal orientation were obtained. The observation result obtained for the electric resistor of sample 1 is shown in FIG. 5, as a representative example of sample 1, sample 2, and sample 3. The magnification of the EBSD image in FIG. 5 is 3500 times. The observation result (enlarged) of the electric resistor of sample 1 is shown in FIG. 6, which is an enlarged view of a surface-joined portion between silicon particles, to make it easier to see joins between silicon particles. The magnification of the EBSD image in FIG. 6 is 10000 times. The observation result obtained for the electric resistor of sample 1C is shown in FIG. 7. The magnification of the EBSD image in FIG. 7 is 3500 times. The triangular figure shown on the right side of the EBSD image in FIGS. 5 and 7 shows the crystal orientation of the silicon.

As shown in FIGS. 5 and 6, it has been confirmed that the electric resistors 1 of sample 1, sample 2, and sample 3 are provided with a particle continuous body 10 and a matrix 11, where the particle continuous body is formed by high-temperature firing to sinter silicon particles that constitute conductive particles 100, used as a raw material, and to thereby connect respective silicon particles to each other, and where the matrix 11 is disposed around the particle continuous body 10. Furthermore, as shown in FIGS. 5 and 6, it has been confirmed that in the electric resistors 1 of sample 1, sample 2, and sample 3, a particle continuous body 10 has a surface-joined portion 101 in which silicon particles 100 are joined to each other. In the EBSD images of FIGS. 5 and 6, the matrix 11 is a region around the particle continuous body 10. This region includes cordierite particles used as a raw material, borosilicate particles, silicon particles whose crystal orientation could not be specified, etc. According to a separate observation, performed by time-of-flight secondary ion mass spectrometry (TOF-SIMS), boron was detected on the surface of the silicon particles constituting the particle continuous bodies 10, so that it is believed that at least a part of the borosilicate was formed on the surface of the particle continuous body 10. This borosilicate can be considered to be derived from silicon and boric acid, formed by a reaction between boric acid and silicon particles (used in the raw material) on the surface of the particle continuous body. From the above results, it can be said that in the electric resistors 1 of sample 1, sample 2, and sample 3, a conductive path is formed by silicon and borosilicate.

On the other hand, as shown in FIG. 7, it was confirmed that the silicon particles in the electric resistors of sample 1C and sample 2C were only in point contact with each other, and were not surface-joined. It is believed that this is because the maximum value of the firing temperature was lower than that when firing samples 1 to 3, so that necking due to sintering of silicon particles (chemical bonding of silicon particles to each other due to sintering) did not advance to a sufficient degree.

The average boundary line length of the surface-joined portions in the electric resistor of sample 1, as obtained by EBSD, was determined using the method described above. The boundary line lengths of respective surface-joined portions (7 locations) in the electrical resistance of sample 1 are shown circled in FIG. 5. The average boundary line length obtained as a result for the electric resistor of sample 1 was 1.2 μm. In addition, the number of surface-joined portions 101 in the electric resistor of sample 1 having a boundary line length of 0.5 μm or more, as obtained by EBSD, was measured using the method described above. As a result, the number present in the electric resistor of sample 1 was found to be 7.

### Measurement of Electrical Resistivity

The initial electrical resistivity of each sample was measured. The electrical resistivity of a prism-shaped sample having a size of 5 mm×5 mm×18 mm was measured by the four-terminal method using a thermoelectric characterization device (ZEM-2 manufactured by the Ulvac Riko company). The measurement temperature was 25° C. The electric resistors of the respective samples were then held in air at 1000° C. for 50 hours. The electrical resistivity of the electric resistor of each sample, after being thus held, was then measured in the same manner as described above. Next, the rate of change in electrical resistance of the electric resistor of each sample was measured using the above-mentioned calculation formula. However, in the case of the electric resistors of samples 3C and 4C, each resistor was held in air at 1000° C. for 10 hours, the electrical resistivity after being thus held was then measured, and the rate of change of electrical resistivity was similarly measured.

Table 1 summarizes the preparation conditions applied to the electric resistors of the respective samples, and various measurement results.

| | | | | Provisional | Main | Electrical resistivity | | Rate of |
|---|---|---|---|---|---|---|---|---|
| Mass ratios of raw materials | | | | firing | firing | | 1000° C. × | change |
| | Boric | | | temperature | temperature | Initial | 50 h | of electrical |
| Si | acid | Cordierite | Kaolin | (° C.) | (° C.) | (Ω · m) | (Ω · m) | resistance |
| 30 | 10 | 60 | 0 | 1250 | 1360 | 2.8 | 3.2 | 14 |
| 30 | 10 | 60 | 0 | None | 1250 | 1.8 | 17.6 | 880 |
| 30 | 4 | 66 | 0 | 1250 | 1330 | 2.3 | 7.8 | 239 |
| 34 | 4 | 62 | 0 | 1250 | 1360 | 0.085 | 0.086 | 1 |
| 60 | 10 | 30 | 0 | 1250 | 1360 | 0.027 | 0.031 | 15 |
| 30 | 4 | 0 | 66 | None | 1250 | 1.51 | — | 854 |
| 30 | 4 | 0 | 66 | None | 1300 | 0.62 | — | 629 |

The following can be understood from the above results. When the electric resistors of sample 1C, sample 2C, sample 3C, and sample 4C are exposed to a high-temperature oxidizing atmosphere at 1000° C. oxidation occurs on the portions of the silicon particle where there is contact between them, causing a SiO₂ film as an insulating oxide film to be formed on these portions. Conductive paths between respective silicon particles are thereby interrupted, causing the electrical resistance of the electric resistor to increase sharply. It is considered that this is due to the fact that the silicon particles of these electric resistors are only in point contact with each other.

However, the electric resistors of sample 1, sample 2, and sample 3 were able to suppress a rapid increase in electrical resistance even when exposed to a high-temperature oxidizing atmosphere at 1000° C. and the thermal resistance is readily improved. This is because the particle continuous bodies have surface-joined portions in which surfaces of respective silicon particles are joined to each other, so that even when the electric resistor is exposed to a high-temperature oxidizing atmosphere at 1000° C., it is unlikely that a conductive path will be cut or restricted at a surface-joined portion.

Furthermore, the effect of suppressing an increase in electrical resistance when exposed to a high temperature oxidizing atmosphere at 1000° C. can readily be achieved, and the thermal resistance of the electric resistor 1 can readily be improved, if the average boundary line length of the surface-joined portions, as obtained using EBSD, is 0.5 μm or more. It should be noted that according to the results obtained for the electric resistors of sample 1C and sample 2C, the electrical resistance when exposed to a high-temperature oxidizing atmosphere of 1000° C. tended to increase as the firing temperature decreased. It is considered that this is because particle continuous bodies having surface-joined portions are not formed when the firing temperature is low.

The present disclosure is not limited to the above embodiments and experimental examples, and various changes can be made without departing from the essence of the disclosure. In addition, each of the configurations shown for the embodiments and experimental examples can be arbitrarily combined. Thus, although the present disclosure has been described in accordance with the embodiments, it is to be understood that the disclosure is not limited to these embodiments, their structures, etc. The present disclosure also includes various modifications, and forms that come within an equivalent range. In addition, various combinations and forms, including combinations and forms that contain one element more or one element less, are also within the scope of the present disclosure

What is claimed is:

1. An electric resistor comprising a particle continuous body in which a plurality of conductive particles are connected, and a matrix around the particle continuous body;
wherein the particle continuous body has surface-joined portions in which surfaces of the conductive particles are joined.

2. The electric resistor according to claim 1, wherein the conductive particles are silicon particles.

3. The electric resistor according to claim 1, wherein the average boundary line length of the surface-joined portions is 0.5 μm or more.

4. The electric resistor according to claim 1, wherein the matrix contains borosilicate and cordierite.

5. The electric resistor according to claim 1, wherein the rate of change in electrical resistance after holding the electric resistor in air at 1000° C. for 50 hours is 200% or less.

6. A honeycomb structure comprising the electric resistor according to claim 1.

7. An electrically heated catalyst device comprising the honeycomb structure according to claim 6.
